(19) United States
(12) Patent Application Publication
(10) Pub. No.: US 2010/0000657 A1
(43) Pub. Date: Jan. 7, 2010

(54) ADHESIVE SHEETS AND METHODS FOR THEIR USE

(76) Inventors: Richard M. Hogan, Weldon Springs, MO (US); John R. Wright, O' Fallon, MO (US); Bret P. Liebeno, O' Fallon, MO (US)

Correspondence Address: HARNESS, DICKEY & PIERCE, P.L.C., P.O. BOX 828, BLOOMFIELD HILLS, MI, 48303, US

(21) Appl. No.: 12/560,812

(22) Filed: Sep. 16, 2009

Related U.S. Application Data
(62) Division of application No. 10/800,096, filed on Mar. 12, 2004.

(51) Int. Cl. B32B 37/14; B29C 47/06

(52) U.S. Cl. 156/106; 264/171.1

(57) ABSTRACT

An adhesive sheet is prepared by coextruding a thermoplastic adhesive material such as a thermoplastic polyurethane and a polymeric material such as a polyolefin that forms a polymeric expendable layer. A process for making a multi-layer impact resistant glass composite made up of alternating glass and plastic layers involves interposing the adhesive sheet between the glass layer and the plastic layer, removing at least one polymeric expendable layer from the adhesive sheet, and pressing the layers together to adhere the glass layer to the plastic layer. In alternate embodiments, the adhesive sheet may be provided as a co-extruded A-B composite sheet or as an A-B-A 3-layer composite sheet.

### FIELD OF THE INVENTION

The present invention relates to adhesive sheets containing a thermoplastic adhesive and a polymeric expendable layer. More specifically, the invention provides processes for manufacturing shatter resistant glass composites using the adhesive sheets to bond alternating layers of glass and thermoplastic.

### BACKGROUND OF THE INVENTION

Extruded adhesive sheets find application in many industrial areas. One such area is in the production of impact resistant glass or shatter resistant glass, which is made up of alternating layers of glass and a thermoplastic material held together by the adhesive sheets. Thermoplastic adhesives are suitable for use in such processes, as they are easy to work with in the lay up of the composite articles, and have suitable adhesive and other properties.

Extruded adhesive sheets may be prepared by conventional extrusion. The extruded sheet is typically calendared on a series of counter-rotating die heat transfer rolls. Thereafter, the sheet is conveyed by a series of rollers to slitting operations, followed by winding onto reels for further use.

Thermoplastic polymers, such as those used in the adhesive described above, sometimes consist of formulations that exhibit characteristics that present challenges in the extrusion, film, calendaring and sheet manufacturing process. Certain characteristics of the polymers can limit production efficiency or increase manufacturing costs.

For example, thermoplastic polymers often exhibit a low extensional melt viscosity. Polymers that exhibit this property tend to sag between the die heat transfer rolls. This can result in lines in the extrudate from dragging across the bottom die lip or air entrapped between the extrudate and the heat transfer roll.

Other thermoplastic polymers exhibit high surface adhesion. Such polymers tend to adhere to one or more of the counter rotating heat transfer rolls. These results in poor or inconsistent cooling, poor pattern transfer from the heat transfer rolls, and surface defects on the extrudate due to inconsistent release. Special coatings are required on the conveyer idlers to prevent adhesion of the sheet or film product to the conveyer idler. The film or sheet product may adhere to itself during the reel take up and winding process resulting in some cases with a completely fused reel that cannot be unwound.

Thermoplastic polymers are also characterized by high extensibility. The solid sheet or film product stretches during the conveying, slitting, and winding operation. To compensate, extremely low inertia conveyer support rolls must be used, together with specialized slitting equipment and accurate winder tension control.

To address some of these difficulties, existing processes that extrude material with these properties often introduce an inter-leaf film prior to the winding or sheeting process. The inter-leaf film does not adhere to the product polymeric extrudate and prevents contact of the cooled solid sheet or film to itself, thereby preventing the material from blocking. However, equipment to pay out the inter-leaf film and wind up the product film or sheet requires expensive and precise tension and tracking mechanisms. Further, since the inter-leaf films are most often thin and easily melted, they generally are not introduced to the extruded material in the melt phase. As such, they do not provide any advantages for running low viscosity, high sag materials, nor do they prevent the extruded polymer from sticking to the calendar or sheet process heat transfer rolls.

It would be desirable to provide extruded thermoplastic polymers in a form that will allow problem free operation, despite the challenges recited above. It would further be desirable to use such polymeric forms to provide adhesive layers for such applications as making impact resistant glass.

### SUMMARY OF THE INVENTION

The invention provides a process for making a multi-layer impact resistant glass composite made up of alternating glass and plastic layers. The process involves interposing an adhesive between the glass layer and the plastic layer and pressing the layers together to adhere the glass layer to the plastic layer. The step of interposing the adhesive involves removing at least one polymeric expendable layer from an adhesive sheet. The adhesive sheet is prepared by coextruding a thermoplastic adhesive material and a polymeric material forming the polymeric expendable layer.

In another embodiment, a co-extruded A-B composite sheet is provided wherein A is a polymeric expendable layer and B is a thermoplastic adhesive layer. In another embodiment, the adhesive sheet is co-extruded as an A-B-A 3-layer composite sheet. In preferred embodiments, the adhesive layer of the co-extruded sheet is made up of a thermoplastic polyurethane adhesive, and the polymeric expendable layer is made up of a polyolefin material, for example polypropylene or polyethylene.

In another embodiment, the invention provides a process of coextruding a polymeric expendable layer on one or more sides of a polymeric product layer such as a thermoplastic adhesive layer. The expendable polymeric layer is preferably selected for superior extensional melt strength, rheological compatibility with the product layer, adhesion properties with the thermoplastic adhesive layer in a range suitable for the application, and high modulus (low extensibility) property. The introduction of an expendable polymeric layer in the melt phase of the process, prior to or at the die, provides support for the low viscosity extensible product polymer between the die and rolls. It also isolates the product polymer from one or both of the counter rotating calendaring or heat transfer rolls, thus eliminating adhesion to the rolls. During the downstream conveying process, the expendable polymeric layer provides support for the extensible product layer and allows the use of less expensive conventional equipment for conveying, splitting, and winding the extradate without stretching or fusing.

The expendable polymeric layer can be introduced on both sides of the product polymeric layer, thereby providing total encapsulation of the product material and preventing contamination throughout the entire extrusion process. In a preferred embodiment, this eliminates expensive and maintenance intensive clean room equipment in the extrusion process.

In another embodiment, the polymeric expendable materials and process conditions can be varied to impart a variety of different surface finishes on the adjacent polymeric product layer surfaces ranging from smooth high gloss to matte low gloss finishes. Coextruded structures using HDPE as the expendable layer tend to impart a lower gloss on the product layer, while structures with polypropylene tend to have a higher gloss. The resulting gloss may be a result of the chemical, theological, or residual gloss characteristics of the expendable layer, or it may be due to an interaction between the expendable and product layers.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein

FIG. 1 illustrates a 2-layer co-extruded product of the invention;

FIG. 2 illustrates a 3-layer co-extruded product of the invention;

FIG. 3 illustrates a 3-layer co-extruded product being calendared on heat transfer rolls;

FIG. 4 illustrates downstream conveying, slitting, winding or other post-extrusion processes using a 3-layer co-extruded product of the invention;

FIG. 5 illustrates the various layers involved in putting together an impact resistant glass composite of the invention; and

FIG. 6 illustrates a multi-layer impact resistant glass composite of the invention after construction.

### DESCRIPTION OF PREFERRED EMBODIMENTS OF THE INVENTION

The following description of the preferred embodiment(s) is merely exemplary in nature and is in no way intended to limit the invention, its application, or uses.

In one aspect, the invention provides a method for preparing a multi-layer plastic film comprising at least one thermoplastic adhesive layer in contact with at least one polymeric expendable layer. The multi-layer plastic film is produced by coextruding a sheet of thermoplastic adhesive and a sheet of the polymeric expendable layer. In a preferred embodiment, the polymeric expendable layer comprises a polyolefin material such as polyethylene or polypropylene. A preferred thermoplastic adhesive layer is a thermoplastic polyurethane adhesive. In a preferred embodiment, the multi-layer plastic film is extruded as an A-B-A composite, wherein B is the adhesive layer and A represents the polymeric expendable layers.

The thickness of the co-extruded layers is not particularly limited by the invention. Depending on the application contemplated, the thermoplastic adhesive layer may vary over a wide range of thicknesses. For the application of producing shatter resistant or impact resistant multi-layer glass composites, it is convenient to use a thermoplastic adhesive layer such as thermoplastic polyurethane with an overall thickness from about 5 mils (0.005″ or about 0.13 mm) to about 90 mils (0.09″ or about 2.3 mm).

Similarly, the thickness of the co-extruded polymeric expendable layer is not particularly limited. For methods described below that involve laying the adhesive on a substrate and removing the polymeric expendable layer, it is convenient to use the polymeric expendable layer with sufficient thickness that its tensile strength is greater than the mechanical bond between it and the adhesive layer. In this application, the polymeric expendable layer will be readily peelable from the adhesive layer. For the application of manufacturing the multi-layer impact resistant glass composites, it is convenient to use polymeric expendable layers having a range of thickness of from about 0.003″ up to about 0.01″. Thicker polymeric expendable layers may be used; however, it is usually preferred to keep the thickness to about 0.01″ in order to reduce costs and material waste.

Co-extrusion is the simultaneous extrusion of two or more polymers through a single die where the polymers are joined together such that they form distinct, well bonded layers forming a single extrusion product. Although relatively new, the process of co-extrusion is well described in the literature, for example in the book Polymer Extrusion by Chris Rauwendaal, pgs. 453-457, the complete disclosure of which is hereby incorporated by reference.

There are several techniques for co-extrusion. A first technique uses a feed block die where melt streams of the various polymers are combined in a relatively small cross section before entering the die. Co-extrusion with such a system is simple and relatively low cost, in that existing dies can be used with little or no modification. However, a drawback is that individual thickness control of the layers is difficult to achieve, there being only an overall thickness control.

A preferred co-extrusion technique involves the use of multimanifold internal dies. The different melt streams of the polymers making up the various layers enter the die separately and join together just before the orifice of the die. Such a process allows for a control of the thickness of the individual layers of the co-extruded product. Multimanifold co-extrusion machines are commercially available with a number of ports to support the production of a variety of co-extruded products. The number of ports available in a particular commercial piece of equipment is a matter of design. Commercially available coextruders are available with up to nine co-extrusion ports. The thickness of each layer co-extruded by up to nine ports in the commercial coextruders can be individually controlled. As a practical matter, it is common to co-extrude the same material in adjacent ports in order to build up a thickness. For example, a thicker layer may be produced by coextruding from three adjacent ports, while a thinner layer may be co-extruded with the thicker layer for co-extrusion from a single port adjacent to the three. Suitable co-extrusion equipment is commercially available from Dow Chemical, Extrusion Dies, Inc., Welex Extrusion Systems, PTI, American Kuhne, Merrit Davis Corporation, and Battenfeld Gloucester.

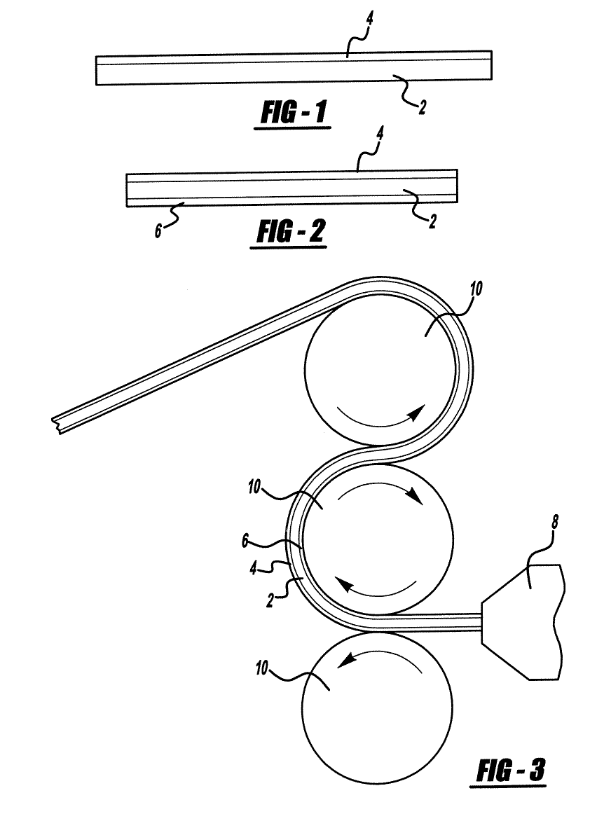

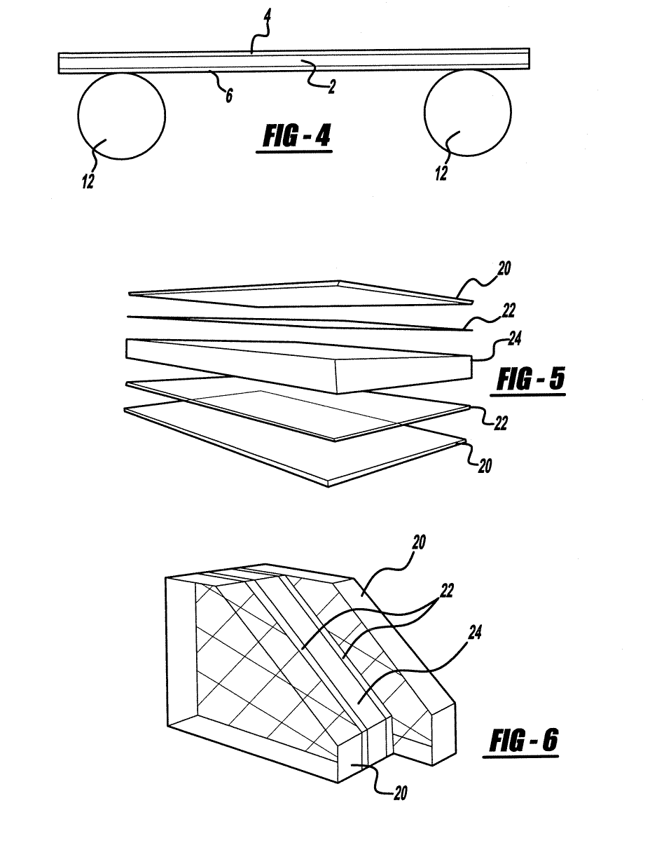

FIG. 1 illustrates a 2-layer A-B composite sheet of the invention, where a polymeric expendable layer 4 is co-extruded on a thermoplastic adhesive layer 2. In a preferred embodiment, the expendable polymeric layer 4 is chosen for its physical properties including modulus and adhesive properties to the adhesive layer 2. In a preferred embodiment, the expendable polymeric layer adheres to the adhesive layer where there is enough strength to enable easy handling of the composite sheet during the co-extrusion process and the glazing process in which it is used. Preferably the expendable polymeric layer has a tensile strength greater than the mechanical bond between it and the adhesive layer. In this way, the polymeric expendable layer may be readily removed from the adhesive layer when called for in the glazing process.

FIG. 2 illustrates a 3-layer co-extruded A-B-A composite sheet where an adhesive layer 2 is co-extruded with a first polymeric expendable layer 4 and a second polymeric expendable layer 6.

The polymeric expendable material is an extruded sheet produced from a thermoplastic polymer or blend of polymers having an advantageous combination of adhesive properties. The thermoplastic polymer should form a sheet that has sufficient adhesion to the adhesive layer to form a unitary co-extruded sheet that may be readily handled and used in the processes of the invention. On the other hand, the adhesion of the thermoplastic polymer to the adhesive layer should not be so great as to prevent its being readily removed when required. As a general rule, preferred thermoplastics for forming the expendable layer will be relatively low in polar groups that would tend to promote adhesion to the preferred thermoplastic polyurethane adhesive layers.

In a preferred embodiment, the polymeric expendable layer is made up of a polyolefin material. Polyolefins are polymers of monomers made up mostly or entirely of carbon and hydrogen, and preferably containing aliphatic repeating units for the most part. Examples of polyolefins include polyethylene and polypropylene. Among polyethylenes, a variety of materials are known, including high density polyethylene and low density polyethylene. Some suitable polyethylenes may contain an amount, usually a minor amount, of one or more comonomers. In a preferred embodiment, the comonomers are hydrocarbons. Examples include, without limitation, propylene, butylene and other C₃-C₈ olefins. In another embodiment, the polyolefin material may contain minor amounts of comonomers that have functional groups. Examples include without limitation acrylic monomers, styrene, acrylonitrile, and the like. When present, the comonomers containing functional groups are nevertheless present at low enough levels so as not to detrimentally change the adhesive properties of the polymeric expendable layer. In a preferred embodiment, the expendable polymeric layer comprises a polypropylene material. The polypropylene may be a homopolymer of propylene, or a copolymer of propylene and other hydrocarbon monomers.

In a preferred embodiment, the thickness of the expendable polymeric layer is from about 0.003″ up to about 0.01″. Polymeric expendable layers having lesser thickness would tend to have such low modulus that there would be a risk they would tear rather than be removable from the adhesive layer. On the other hand, polymeric expendable layers of thickness greater than about 0.01″ may be used in the invention. Generally, however, thicker polymeric layers do not significantly improve the extrusion properties, and so are less preferred because of the added expense.

In a preferred embodiment, the adhesive layer 2 is made up of a thermoplastic polyurethane adhesive. The thickness of the thermoplastic polyurethane layer is chosen for best results in the process contemplated for its use. For the glazing operation described below, it is convenient to choose the thermoplastic polyurethane adhesive layer with a thickness of from about 0.005″-0.09″ (about 0.13 mm to about 2.3 mm).

The adhesion level between the expendable layer and the polymeric layer should be less than the cohesive strength of the expendable layer to prevent the polymeric layer from being contaminated with deposits from the expendable layer. Also, the adhesion level should not exceed the yield strength of the polymeric layer or cause distortion of the polymeric layer when separating the two layers.

In a preferred embodiment, the composite sheets of the invention are extruded through a sheet die and calendared on heat transfer rolls. FIG. 3 illustrates the process whereby a 3-layer A-B-A composite of the invention are extruded from a sheet die 8 and calendared on heat transfer rolls 10. FIG. 3 illustrates an advantage of the invention in that the rollers 10 are isolated from the adhesive layer 2 by the intervening polymeric expendable layers 4 and 6.

The adhesive layer may be made of one or more than one individual layers. The individual layers may be the same or different. For example, a plurality of identical adhesive sheets may be co-extruded together in order to build up a thickness. Alternatively, the adhesive layer may be made of a plurality of (preferably two) individuals. In one embodiment described below, the individual layers may have different adhesive properties—that is a first individual adhesive layer has a first set of properties, and a second individual adhesive layer has a second set of adhesive properties.

The adhesive layer may be any thermoplastic adhesive composition capable of being extruded into a sheet. For glazing operations, a preferred adhesive material is thermoplastic polyurethane adhesive. For extrusion into sheets, thermoplastic polyurethanes are provided as soluble polymers prepared by a reaction of a diisocyanate with a diol to obtain hydroxyl terminated polyurethane. Triols or higher functional hydroxyl components may be used, which introduces a slight amount of crosslinking into the thermoplastic polyurethane. The crosslinking if present is to be kept at a low enough level that the thermoplastic property of the material is retained.

Preferred diols include polyester diols prepared by condensation polymerization of diacid monomers with diol monomers. Such polyester polyols are well known in the art and are commercially available. The diacid monomers preferably contain from about 2-15 carbon atoms and are preferably saturated. Examples include without limitation malonic acid, succinic acid, glutaric acid, adipic acid, sebacic acid, and cyclohexane dicarboxylic acid. Diols include those having from about 2 to 15 carbon atoms and are also preferably saturated. Examples include without limitation ethylene glycol, propylene glycol, diethylene glycol, dipropylene glycol, 1,3-butylene glycol, 1,4-butanediol, 1,6-hexanediol, cyclohexanedimethanol, and neopentyl glycol. Triols may be included in a lesser amount than the diols and include without limitation, glycerol and trimethylolpropane. The polyester polyol generally has a number average molecular weight from about 500 to about 10,000.

To prepare the thermoplastic polyurethane adhesive composition, a polyisocyanate, preferably a diisocyanate, is reacted with the polyol composition such as the polyester polyol described above. The diol component is a provided in a slight excess, for example, on the order of 0.1% excess or more, in order to obtain a hydroxyl terminated polymer. The diisocyanate may be saturated or unsaturated, and contain aliphatic or cycloaliphatic groups. Although saturated diisocyanates are preferred in a sense because the resulting polyurethane polymers are more resistant to ultraviolet radiation, it is common to use aromatic diisocyanates in order to gain flexibility and to reduce cost. Saturated diisocyanates containing aliphatic or cycloaliphatic groups include without limitation isophorone diisocyanate, hexamethylene diisocyanate, and cyclohexane diisocyanate. A number of other diisocyanates are commercially available and may be used. Preferred aromatic diisocyanates include 4,4′-MDI, 2,4′-MDI, 2,4-TDI, and 2,6-TDI.

Thermoplastic polyurethane adhesives are commercially available. One example is TPU 2103-90AE sold by Dow. Other suppliers include BASF Corporation, Merquinsa, Bayer Corporation, Noveon, and Huntsman Chemical.

The expendable layer is selected for its rheological and other properties. As discussed above, preferred expendable layers include polyolefins such as polyethylene and polypropylene. As a practical matter, the expendable polymeric layer should be peelable. The tensile strength of the polymer expendable layer should be greater than the strength of the mechanical bond to the adhesive layer.

In one embodiment, the multilayer A-B or A-B-A coextruded sheets may be used in a process for making impact or shatter resistant glass. Impact resistant or shatter resistant glass generally consists of alternating glass and plastic layers held together with adhesives. The number of alternating glass and plastic layers, as well as the relative thickness of the glass and plastic may be varied according to the end use. Uses of such glass plastic composites range from shatter resistant windshields in automobiles to bullet-proof glass for banks or other commercial establishments. For shatter resistant windshields, the glass and plastic layers may be relatively thin. For bullet-proof applications, thicker glass and plastic layers would be chosen.

The adhesive layer of the current invention must provide a good bond between layers of dissimilar materials such as glass, polycarbonate and/or acrylic plastic. It must also be able to absorb large thermal and mechanical shocks common among security glazing. Furthermore, preferred adhesives should offer years of service life without delamination and provide ultraviolet screening protection. Furthermore, the preferred adhesives must remain tough and flexible over a wide temperature range. It has been found in the industry that thermoplastic polyurethane adhesive sheets possess suitable properties; accordingly thermoplastic polyurethane adhesives are used in glazing operation. Sheet adhesives for security glazing, not containing the co-extruded expendable layer or layers of the invention, are commercially available for example from Stephens urethane.

The plastic material in the impact or shatter resistant glass composite may be any material capable of withstanding the impact contemplated for the application. Generally, thermoplastic and thermoplastics may be used, with thermoplastic materials being preferred. Non-limiting examples of suitable thermoplastic materials include polycarbonates and polyacrylates. In a preferred embodiment, polycarbonate is used.

FIG. 5 illustrates an impact or shatter resistant glass composite made according to the invention. Adhesive layers 22 are disposed between glass layers 20 and plastic layer 24.

FIG. 6 shows a cross section and prospective view of a fully constructed laminated safety glass panel. Glass layers 20 are held in contact with a plastic layer 24 by intervening adhesive layers 22. In a non-limiting example of a process of glazing using the sheet adhesive of the invention, an A-B film is first applied to a glass layer with the B-layer to the glass. The B-layer is an adhesive material such as described above and A layer is an expendable polymeric layer. The A-B film may be produced by coextruding a single expendable layer A with an adhesive layer B. Alternatively, the film may be coextruded as an A-B-A 3-layer film, with one of the expendable layers being removed prior to laying the B side down on the glass. The expendable layer A is then removed to expose the adhesive layer. Next a plastic layer is laid on top of the glass containing the exposed adhesive layer. The plastic and glass layers are then bonded by applying vacuum (to help remove entrained air or other gases) and heating while applying pressure to the glass and plastic to adhere them one to the other.

Continuing, an A-B film produced as described above is then laid on the plastic with the B side to the plastic layer. The expendable polymeric layer A is then removed to expose the adhesive layer and a second glass layer is laid onto the exposed adhesive layer. The vacuum pressure and heating steps are repeated to bond the second glass layer to the plastic. The entire process may then be repeated until the desire number of layers of alternating glass and plastic material have been constructed.

Alternative processes are also possible. For example, the A-B film may be first applied to a plastic layer with the adhesive side down and the expendable layer removed. Thereafter, the glass layer may be laid onto the plastic layer and the layers sealed by applying vacuum and heating under pressure as described above. The process may continue by applying the A-B film to the opposite side of the plastic layer and removing the expendable layer. Thereafter the second glass layer may be applied to the plastic and sealed as before. In yet another alternative, the second glass layer may be prepared separately by applying the A-B film to the second glass layer with the adhesive side down. Then the expendable layer may be removed from the second glass layer. Then the second glass layer with the exposed adhesive may be applied to the previously formed glass plastic construction.

Other processes may also be used. Alternatively, at least some of the process steps described above may be automated.

Whether the adhesive layer is laid on a glass layer or a plastic layer, it is preferred to use enough adhesive sheets to cover the substrate allowing for example 1 to 5 mm of edge trim. In a preferred embodiment, the components of the laminate are laid up until the final ply, whether it is glass or another material. The edges and corners should be as flush as possible and the excess adhesive layer should be carefully trimmed away.

As mentioned above, the A-B or A-B-A composite co-extruded sheets of the invention may contain a plurality of individual adhesive layers B. In one embodiment, the B layer contains two individual layers of adhesive. The first individual layer may be a stronger adhesive than the second individual layer. In a preferred embodiment, the stronger adhesive comprises an aliphatic polyurethane adhesive, while the weaker adhesive comprises another thermoplastic polyurethane. In the glazing process, the sheets may be used in the following way. An A-B′-B″ composite or a an A-B′-B″-A composite is prepared by coextrusion of the respective individual layers. In this embodiment, the co-extruded sheet is contacted with a sheet of glass comprising the outside glass layer of a laminated safety glass panel as shown in FIG. 6. The B″ layer is attached to the glass, and the expendable A layer is removed, exposing the weaker adhesive layer B′. A frame such as vinyl or aluminum is then applied by contact with the exposed B′ layer, where the tacky B′ layer provides some holding ability while the fabrication of the panel is completed. In a preferred embodiment, the adhesive layer B′ may be made of the same material as the sealants in the frame.

The description of the invention is merely exemplary in nature and, thus, variations that do not depart from the gist of the invention are intended to be within the scope of the invention. Such variations are not to be regarded as a departure from the spirit and scope of the invention. The invention has been described above with respect to preferred embodiments. Further non-limiting description and illustration is given in the following Examples.

### EXAMPLE 1

### Co-Extrusion with Expendable Layer on One Side

A layer of aliphatic TPU was co-extruded with an expendable layer of high density polyethylene on one side. An A layer was made of Dow 12450N HDPE (0.003″) and a B layer was made PE399-100 aliphatic TPU (0.030″). Layers A and B were fed with heated extruders into a Cloeren 5 layer dual plane feed block having a BB-AAA plug with a temperature profile of 375° F.

The A layer extruder was a Davis Standard 1.5″ 24:1 L/D air cooled electrically heated extruder. It was operated with a high work barrier screw and a UCC mixer. Screens were 20-40-60-80, and the temperature profiles were 375° F. in the barrel zone, gate, and adapters. The screw speed was 25 rpm and the barrel pressure was 450-500 psi. The motor load was 30-40%.

The B layer extruder was a Crown 3.5″ 32:1 L/D air cooled electrically heated extruder. It was operated with a high work barrier screw and a UCC mixer. Screens were 20-40-60-80. The temperature profiles were 375° F. in the gate, and adapters. In the barrel zones, the temperature profile was 345° F., 365° F., 375° F., 375° F., 375° F., 375° F., 375° F., and 375° F. The screw speed was 10 rpm and the barrel pressure was 1480-1550 psi. The motor load was 30-40%.

From the feed block, the A and B layers were fed through a Cloeren Epoch II coextrusion sheet die. The co-extruded A-B system was taken up on a three roll down stack embossing roll stand and passed to two 2500 watt thermal slitters set at 30% power. The roll size was 12 inch diameter by a 30 inch face width. The roll type was a top matte finish, center matte finish, and bottom matte finish. Roll temperatures were top 85° F., center 75° F., and bottom 70° F. The roll gap was 0.027 inch and the roll speed was 6 feet per minute.

### EXAMPLE 2

### Co-Extrusion with Expendable Layer on Both Sides

A sheet of tpu with expendable layers of HDPE on both sides was produced as an A-B-A structure. The B layer was PE399-100 aliphatic tpu (0.040″), while each A layer was Dow 12450N HDPE (0.005″). The width was 24″ finished.

The B layer extruder was a Davis Standard 1.5″ 24:1 L/D air cooled electrically heated extruder, operating with a high work barrier screw with a UCC mixer. The screens were 20-40-60-80 mesh. The temperature profile in the barrel zones, gate, and adapters was 375° F. The screw speed was 85 rpm, the barrel pressure was 700-750 psi, and the motor load was 60-70%.

The A layer extruder was a Crown 3.5″ 32:1 air cooled electrically heated extruder, operating with a high work barrier screw with a UCC mixer. Screens were 20-40-60-80 mesh. The temperature profiles were 375° F. in the gate, and adapters. In the barrel zones, the temperature profile was 345° F., 365° F., 375° F., 375° F., 375° F., 375° F., 375° F., and 375° F. The screw speed was 28 rpm and the barrel pressure was 1700-1750 psi. The motor load was 60-65%.

The feed block was a Cloeren 5 layer dual plane type with a BB-AAA plug and a temperature profile of 375° F. The co-extrusion die was a Cloeren Epoch II co-extrusion sheet die with a die gap of 0.050″. The temperature profile was 385° F., 385° F., 385° F., 385° F., and 385° F.

The co-extruded A-B-A system was taken up on a three roll down stack embossing roll stand and passed to two 2500 watt thermal slitters set at 50% power. The roll size was 12 inch diameter by a 30 inch face width. The roll type was a top matte finish, center matte finish, and bottom matte finish. Roll temperatures were top 85° F., center 75° F., and bottom 70° F. The roll gap was 0.027 inch and the roll speed was 4 feet per minute.

1. A process of glazing by interposing sheet adhesive between glass and plastic layers, comprising:
providing a first glass layer;
laying a co-extruded A-B film on the first glass layer with the B layer to the glass, wherein the B layer is an adhesive material and the A layer is an expendable polymeric layer; and
removing the extendable layer to expose the adhesive layer; and
laying a plastic layer on the adhesive layer, wherein the plastic layer has a first and second side, and wherein the first side is in contact with the adhesive.

2. A process according to claim 1, further comprising the steps of:
laying an A-B film on the second side of the plastic layer with the B side to the plastic layer;
removing the expendable polymeric layer to expose the adhesive layer; and
laying a second glass layer on the exposed adhesive layer.

3. A method according to claim 1, further comprising preparing the A-B film by co-extruding an A-B-A laminate and removing one of the A layers.

4. A method according to claim 2, further comprising preparing the A-B film by co-extruding an A-B-A laminate and removing one of the A layers.

5. A method according to claim 1, wherein the expendable layer comprises a polyolefin.

6. A method according to claim 1, wherein the expendable layer comprises polyethylene.

7. A method according to claim 1, wherein the expendable layer comprises polypropylene.

8. A method according to claim 1, wherein the adhesive layer comprises thermoplastic polyurethane.

9. A method according to claim 1, wherein the adhesive layer has a thickness of 0.005-0.090 inches.

10. A method according to claim 1, wherein the expendable polymeric layer has a thickness of 0.003-0.005 inches.

11. A method according to claim 1, wherein the plastic layer comprises polycarbonate.

12. A method according to claim 1, wherein the plastic layer comprises a thermoplastic.

13.-30. (canceled)

31. A method of preparing a multilayer plastic film comprising at least one thermoplastic polyurethane layer in contact with at least one polymeric expendable layer, comprising:
co-extruding a sheet of thermoplastic polyurethane and a sheet of the polymeric expendable layer.

32. A method according to claim 31, wherein the polymeric expendable layer comprises a polyolefin.

33. A method according to claim 31, wherein the polymeric expendable layer comprises polyethylene.

34. A method according to claim 31, wherein the polymeric expendable layer comprises polypropylene.

35. A method according to claim 31, wherein the multilayer plastic film comprises A-B-A, where B is the at least one thermoplastic polyurethane layer and A is the polymeric expendable layer.

36. A method according to claim 31, wherein the thermoplastic polyurethane layer has a thickness of 0.005-0.090 inches.

37. A method according to claim 31, wherein the polymeric expendable layer has a thickness of 0.003-0.010 inches.

38. A method according to claim 31, wherein the polymeric expendable layer has a thickness of 0.003-0.005 inches.

39. A process for making a multilayer impact resistant glass composite, comprising the steps of:
providing a glass layer;
providing a plastic layer;
interposing an adhesive between the glass layer and the plastic layer;
pressing the layers together to adhere the glass layer to the plastic layer;
wherein the step of interposing the adhesive comprises removing at least one polymeric expendable layer from an adhesive sheet,
wherein the adhesive sheet is prepared by co-extruding a thermoplastic adhesive material and a polymeric material forming the polymeric expendable layer.

40. A method according to claim 39, wherein the thermoplastic adhesive material comprises thermoplastic polyurethane.

41. A method according to claim 39, wherein the polymeric material forming the polymeric expendable layer comprises a polyolefin.

42. A method according to claim 39, wherein the polymeric material forming the polymeric expendable layer comprises a polypropylene.

43. A method according to claim 39, wherein the polymeric material forming the polymeric expendable layer comprises a polyethylene.

44. A method according to claim 39, wherein the adhesive sheet comprises a thermoplastic polyurethane layer in contact with a polyolefin layer, and wherein the tensile strength of the polyolefin layer is greater than the mechanical bond between the polyolefin and the thermoplastic polyurethane layer.

45. A method according to claim 44, wherein the polyolefin layer is on one side of the thermoplastic polyurethane layer.

46. A method according to claim 44, wherein the polyolefin layer is on both sides of the thermoplastic polyurethane layer.
